(19) United States
(12) Patent Application Publication
(10) Pub. No.: US 2012/0278758 A1
(43) Pub. Date: Nov. 1, 2012

(54) IMAGE BROWSING SYSTEM AND METHOD FOR ZOOMING IMAGES AND METHOD FOR SWITCHING AMONG IMAGES

(75) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/171,669

(22) Filed: Jun. 29, 2011

(30) Foreign Application Priority Data
Apr. 26, 2011 (CN) 201110104985.9

(51) Int. Cl. G06F 3/048

(52) U.S. Cl. 715/800

(57) ABSTRACT

An image browsing system includes an electronic device, and a mouse with a sensor for generating a detecting signal based on an operation performed by a user. The electronic device includes a determining unit and a zooming unit. The mouse controls the movements of a cursor in a first state, and controls the electronic device to zoom in or out a current display image in a second state. The determining unit determines whether the current state is the second state, and the detecting signal is a first zooming signal, or a second zooming signal. The zooming unit zooms in the current display image when the current state is the second state, and the detecting signal is the first zooming signal. The zooming unit zooms out the current display image when the current state is the second state, and the detecting signal is the second zooming signal.

### BACKGROUND

1. Technical Field

The present disclosure relates to an image browsing system; and particularly to a method for zooming an image and a method for switching among images using a mouse.

2. Description of Related Art

Having opened an image file in a folder of image files on a computer, a user must move a mouse to place it on an icon indicating image browse functions, for example on the “previous” button, or the “next” button, or on the buttons for zooming in and out, and then left click to select a different image, or to zoom in or out of an image, or to carry out other operations. This is not the most convenient procedure.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the two views.

FIG. 1 is a block diagram of an image browsing system in accordance with an embodiment.

FIG. 2 is a flowchart of an image browsing method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

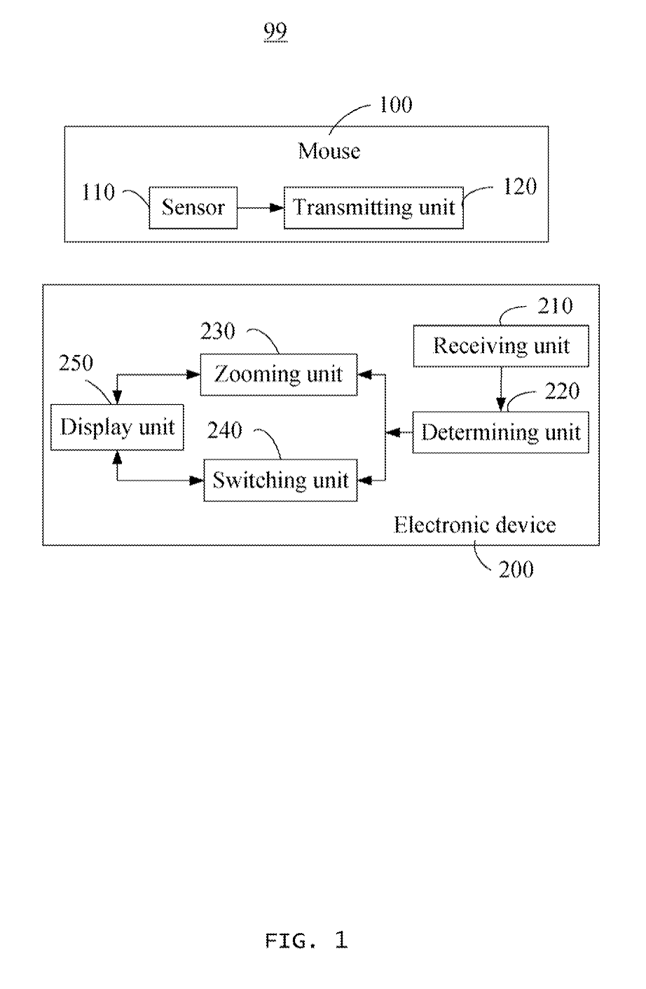

Referring to FIG. 1, an image browsing system 99 includes an electronic device 200 with display functions, and a mouse 100 used as an input device for the electronic device 200. In a first state, the mouse 100 is used for controlling the movements of a cursor and to select the functions which the electronic device 200 offers by display. In a second state, the movements of the mouse 100 control the electronic device 200 to zoom in or out of a current display image, or to switch among images in a folder of image files. The first state and second state are defined by the user. The electronic device 200 may be computer.

In the embodiment, the first and second states are defined according to a speed V1 and a distance S1 the mouse 100 traveled in a set period of time. The first state occurs when the speed V1 is less than the predetermined speed V0, or the distance S1 is less than the predetermined distance S0. The second state occurs when the speed V1 is at least a predetermined speed V0, and the distance S1 is at least a predetermined distance S0. The period of time is defined by the user, such as 0.2 second.

In other embodiments, the first and second states also can be defined by whether the active window of the electronic device 200 shows one image only. The first state occurs when the active window shows more than one image or no image, while the second state occurs when the active window shows only one image.

The mouse 100 includes a sensor 110 and a transmitting unit 120. The sensor 110 is used for generating a detecting signal according to an operation performed by the user on the mouse 100, and transmitting the detecting signal to the electronic device 200. When the operation is different, the detecting signal is different. The mouse 100 and the electronic device 200 may communicate with wires or wirelessly.

The electronic device 200 includes a receiving unit 210, a determining unit 220, a zooming unit 230, a switching unit 240, and a display unit 250. The receiving unit 210 is used for receiving the detecting signal transmitted by the transmitting unit 120.

The determining unit 220 is used for determining whether the current state is the second state, and whether the detecting signal is the first zooming signal, the second zooming signal, the first switching signal, or the second switching signal, and generating a control signal according to the determinations.

When it is determined that the current state is the second state, and that the detecting signal is the first zooming signal, the determining unit 220 generates a first control signal, and transmits the first control signal to the zooming unit 230 such that the zooming unit 230 zooms in the current display image in response to the first control signal.

When it is determined that the current state is the second state, and that the detecting signal is the second zooming signal, the determining unit 220 generates a second control signal, and transmits the second control signal to the zooming unit 230 such that the zooming unit 230 zooms out the current display image in response to the second control signal.

When it is determined that the current state is the second state, and that the detecting signal is the first switching signal, the determining unit 220 generates a third control signal, and transmits the third control signal to the switching unit 240 such that the switching unit 240 controls the display unit 250 to display an image with next lowest numerical file number in response to the third control signal.

When it is determined that the current state is the second state, and that the detecting signal is the second switching signal, the determining unit 220 generates a fourth control signal, and transmits the fourth control signal to the switching unit 240 such that the switching unit 240 controls the display unit 250 to display an image with next highest numerical file number in response to the fourth control signal.

In the embodiment, when the determining unit 220 determines that the user has moved the mouse 100 forward, the detecting signal is considered as the first zooming signal. When the determining unit 220 determines that the user has moved the mouse 100 backward, the detecting signal is considered as the second zooming signal. When the determining unit 220 determines that the user has moved the mouse 100 to the left, the detecting signal is considered as the first switching signal. When the determining unit 220 determines that the user has moved the mouse 100 to the right, the detecting signal is considered as the second switching signal.

Using the above image browsing system 99, the user moves the mouse 100 to control the electronic device 200 to zoom in or out the current display image, or switch among the images, it is convenient.

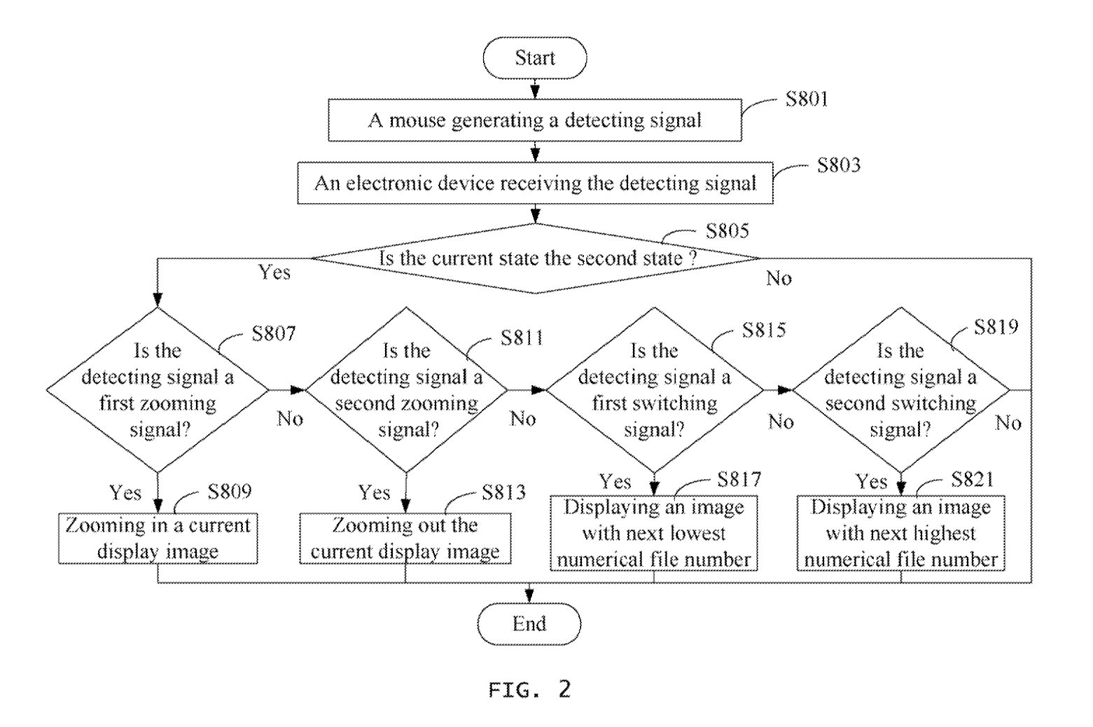

Referring to FIG. 2, an image browsing method is used for controlling an electronic device with display functions to zoom in or out a current display image, or switch among images using a mouse. The electronic device may be computer. In a first state, the mouse is used for controlling the movement of a cursor and to select the functions which the electronic device offers by display. In a second state, the movements of the mouse control the electronic device to zoom in or out of a current display image, or to switch among images. The first state and second state are defined by the user. In the embodiment, the first and second states are defined according to a speed V1 and a distance S1 the mouse traveled in a set period of time. The first state occurs when the speed V1 is less than the predetermined speed V0, or the distance S1 is less than the predetermined distance S0. The second state occurs when the speed V1 is at least a predetermined speed V0, and the distance S1 is at least a predetermined distance S0. The period of time is defined by the user, such as 0.2 second. In other embodiments, the first state and second state also can be defined by whether the active window of the electronic device shows only one image. The first state occurs when the active window shows more than one image or no image, while the second state occurs when the active window shows only one image. The image browsing method includes the following steps.

In step S801, the mouse detects an operation performed by a user on the mouse, and generates a detecting signal according to the operation. When the operation is different, the detecting signal is different.

In step S803, the electronic device receives the detecting signal generated by the mouse.

In step S805, determining whether the current state is the second state. If the current state is the second state, step S807 is implemented. If the current state is the first state, the procedure is ended.

In step S807, determining whether the detecting signal is a first zooming signal. If the detecting signal is the first zooming signal, step S809 is implemented. If the detecting signal is not the first zooming signal, step S811 is implemented.

In step S809, the electronic device zooms in a current display image.

In step S811, determining whether the detecting signal is a second zooming signal. If the detecting signal is the second zooming signal, step S811 is implemented. If the detecting signal is not the second zooming signal, step S815 is implemented.

In step S813, the electronic device zooms out the current display image.

In step S815, determining whether the detecting signal is a first switching signal. If the detecting signal is the first switching signal, step S817 is implemented. If the detecting signal is not the first switching signal, step S819 is implemented.

In step S817, the electronic device displays an image with next lowest numerical file number.

In step S819, determining whether the detecting signal is a second switching signal. If the detecting signal is the second switching signal, step S821 is implemented. If the detecting signal is not the second switching signal, the procedure is ended.

In step S821, the electronic device displays an image with next highest numerical file number.

In the embodiment, when the user has moved the mouse forward, the detecting signal is considered as the first zooming signal. When the user has moved the mouse backward, the detecting signal is considered as the second zooming signal. When the user has moved the mouse to the left, the detecting signal is considered as the first switching signal. When the user has moved the mouse to the right, the detecting signal is considered as the second switching signal.

It is noteworthy that an order of the steps S807, S811, S815, and S819 is changeable.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An image browsing system, comprising:
a mouse with a sensor for generating a detecting signal based on an operation performed by a user on the mouse, the detecting signal being different when the operation is different; and
an electronic device with display functions comprising:
a determining unit; and
a zooming unit;
wherein, in a first state, the mouse is used for controlling the movement of a cursor and to select the functions which the electronic device offers; in a second state, the movements of the mouse control the electronic device to zoom in or out a current display image; the determining unit is used for determining whether the current state is the second state, and whether the detecting signal is a first zooming signal or a second zooming signal; the determining unit generates a first control signal when the current state is the second state, and the detecting signal is the first zooming signal; the determining unit generates a second control signal when the current state is the second state, and the detecting signal is the second zooming signal; the zooming unit is used for zooming in the current display image in response to the first control signal, and zooming out the current display image in response to the second control signal.

2. The image browsing system according to claim 1, wherein when the determining unit determines that the user has moved the mouse forward, the detecting signal is considered as the first zooming signal; when the determining unit determines that the user has moved the mouse backward, the detecting signal is considered as the second zooming signal.

3. The image browsing system according to claim 2, further comprising a display unit and a switching unit; the mouse being further used for controlling the electronic device to switch among images; the determining unit being further used for determining whether the detecting signal is a first switching signal or a second switching signal; the determining unit generating a third control signal when the current state is the second state, and the detecting signal is the first switching signal; the determining unit generates a fourth control signal when the current state is the second state, and the detecting signal is the second switching signal; the switching unit being used for controlling the display unit to display an image with next lowest numerical file number in response to the third control signal, and controlling the display unit to display an image with next highest numerical file number in response to the fourth control signal.

4. The image browsing system according to claim 3, wherein when the determining unit determines that the user has moved the mouse to the left, the detecting signal is considered as the first switching signal; when the determining unit determines that the user has moved the mouse to the right, the detecting signal is considered as the second switching signal.

5. The image browsing system according to claim 1, wherein the first state and second state are defined according to a speed and a distance the mouse traveled in a set period of time; the first state occurs when the speed is less than the predetermined speed, or the distance is less than the predetermined distance; the second state occurs when the speed is at least a predetermined speed, and the distance is at least a predetermined value.

6. The image browsing system according to claim 1, wherein the first state and second state are defined by whether the active window of the electronic device shows only one image; the first state occurs when the active window shows more than one image, or no image, while the second state occurs when the active window shows only one image.

7. An image zooming method, controlling an electronic device to display images using a mouse; in a first state, the mouse being used for controlling the movements of a cursor and to select functions of the electronic device; in a second state, the movements of the mouse controlling the electronic device to zoom in or out a current display image; the image zooming method comprising:
the electronic device receiving the detecting signal transmitted by the mouse, the detecting signal being generated according to an operation performed by a user on the mouse, the detecting signal being different when the operation is different;
determining whether the current state is the second state;
if it is determined that the current state is the second state, determining whether the detecting signal is a first zooming signal; and
if it is determined that the detecting signal is the first zooming signal, the electronic device zooming in the current display image.

8. The image zooming method according to claim 7, further comprising:
if it is determined that the detecting signal is not the first zooming signal, determining whether the detecting signal is a second zooming signal; and
if it is determined that the detecting signal is the second zooming signal, the electronic device zooming out the current display image.

9. The image zooming method according to claim 8, wherein when the user has moved the mouse forward, the detecting signal is considered as the first zooming signal; and when the user has moved the mouse backward, the detecting signal is considered as the second zooming signal.

10. The image zooming method according to claim 7, wherein the first state and second state are defined according to a speed and a distance the mouse traveled in a set period of time; the first state occurs when the speed is less than the predetermined speed or the distance is less than the predetermined distance; the second state occurs when the speed is at least a predetermined speed and the distance is at least a predetermined value.

11. The image zooming method according to claim 7, wherein the first state and second state are defined by whether the active window of the electronic device shows only one image; the first state occurs when the active window shows more than one image or no image, while the second state occurs when the active window shows only one image.

12. An image switching method, controlling an electronic device to display images using a mouse; in a first state, the mouse being used for controlling the movements of a cursor and to select functions which the electronic device offers by display; in a second state, the movements of the mouse controlling the electronic device to switch among the images;
the image switching method comprising:
the electronic device receiving the detecting signal transmitted by the mouse, the detecting signal being generated according to an operation performed by a user on the mouse, the detecting signal being different when the operation is different;
determining whether the current state is the second state;
if it is determined that the current state is the second state, determining whether the detecting signal is a first switching signal; and
if it is determined that the detecting signal is the first switching signal, the electronic device displaying an image with next lowest numerical file number.

13. The image switching method according to claim 12, further comprising:
if it is determined that the detecting signal is not the first switching signal, determining whether the detecting signal is a second switching signal; and
if it is determined that the detecting signal is the second switching signal, the electronic device displaying an image with next highest numerical file number.

14. The image switching method according to claim 13, wherein when the user has moved the mouse to the left, the detecting signal is considered as the first switching signal; and when the user has moved the mouse to the right, the detecting signal is considered as the second switching signal.

15. The image switching method according to claim 12, wherein the first state and second state are defined according to a speed and a distance the mouse traveled in a set period of time; the first state occurs when the speed is less than the predetermined speed or the distance is less than the predetermined distance; the second state occurs when the speed is at least a predetermined speed and the distance is at least a predetermined value.

16. The image switching method according to claim 12, wherein the first state and second state are defined by whether the active window of the electronic device shows only one image; the first state occurs when the active window show more than one or no image, while the second state occurs when the active window comprises only one image.
